(19) United States
(12) Patent Application Publication
(10) Pub. No.: US 2020/0208342 A1
(43) Pub. Date: Jul. 2, 2020

(54) USE OF DIATOMACEOUS EARTH IN TEXTILES AND TEXTILES FILAMENT AND FIBERS

(71) Applicants: KYLE BULLOCK, PAULINE, SC (US); DAN SHORT, PARIS, KY (US); 2 ATOM EARTH, INC., BLACKSBURG, SC (US)

(72) Inventors: KYLE BULLOCK, PAULINE, SC (US); DAN SHORT, PARIS, KY (US)

(73) Assignee: 2 ATOM EARTH, INC., BLACKSBURG, SC (US)

(21) Appl. No.: 16/626,076

(22) PCT Filed: Jul. 2, 2018
(86) PCT No.: PCT/US18/40585

§ 371 Date: Dec. 23, 2019

Related U.S. Application Data
(60) Provisional application No. 62/527,038, filed on Jun. 30, 2017.
(60) Provisional application No. 62/611,211, filed on Dec. 28, 2017.
(60) Provisional application No. 62/642,254, filed on Mar. 13, 2018.

(51) Int. Cl. D06M 11/79; A01M 1/20

(52) U.S. Cl. CPC D06M 11/79; A01M 1/20

(57) ABSTRACT

An apparatus and process of making the apparatus is provided in which consumer goods have applied thereto a substantially permanent amount of embedded diatomaceous earth. A portion of the diatomaceous earth is exposed on the surface of the consumer good and when encountered by an insect, will cause sufficient injury to the insect that the death of the insect results in a few days.

### RELATED APPLICATIONS

This application claims the benefit of U.S. Application Ser. No. 62/527,038 filed on. Jun. 30, 2017, U.S. Serial Application No. 62/611,211 filed on Dec. 28, 2017, and U.S. Serial Application No. 62/642,254, filed Mar. 13, 2018 and which are all incorporated herein by reference.

### FIELD OF THE INVENTION

This invention is directed towards use of diatomaceous earth within manufactured articles such as textiles, textile filaments, textile fibers, and foam products so as to bring about an improvement to a resulting article that makes the article have an inherent anti-insecticide property.

### BACKGROUND OF THE INVENTION

This invention relates to methods of controlling insect populations such as bed bugs, mosquitoes, cockroaches, and similar insects that will frequent or reside in textile and textile products such as bedding, carpet, upholstery, pillows and draperies. Heretofore, conventional methods to control bed bugs and similar insect pests require the use of insecticides or treatment of room with heaters to bring about a destruction of the insects. To the extent fabrics or textiles are treated with chemical insecticides, the persistence of the chemicals and subsequent exposure to humans of the insecticide has limited the appeal and adoption of such practices.

Accordingly, there remains room for improvement and variation within the art.

### SUMMARY OF THE INVENTION

It is one aspect of at least one of the present embodiments to provide for a process in which diatomaceous earth can be permanently adhered to at least one of a fiber, a fiber containing fabric, articles of manufacture using the fiber and fabric, and foam products such as pillow and bedding wherein an effective amount of diatomaceous earth is secured to the fiber and fabric thereby killing insects that may come in contact with the fabric.

It is a further aspect of at least one embodiment in the present invention to provide a product of a process of applying diatomaceous earth to a molten polymer fiber such that the diatomaceous earth is partially embedded in the fiber while having a portion of the diatomaceous earth exposed on the surface of the fiber.

It is a further aspect of at least another embodiment of the present invention to provide for a process of securing a layer of diatomaceous earth to a polymer film.

It is a further aspect of at least one embodiment of the present invention to provide for a process in the resulting product of incorporating an effective amount of diatomaceous earth within a foamed product such as a pet pillow, bed pillow, upholstery foam, bedding foam, and other foam products so as to provide a foam contact surface having an effective amount of diatomaceous earth within the foam that will kill insects that come in contact with the foam.

It is yet another aspect of at least one embodiment of the present invention to provide for a process and the resulting product wherein the fabric component of carpet backing, the tufted area of the carpet, filler cloth used in bedding, ticking used in bedding, fabric used in curtains, draperies, and mosquito netting all have at least fibers and/or a fabric surface having diatomaceous earth permanently attached to the surface and having a effective amount of exposed diatomaceous earth such that insects coming in contact with the fiber or fabric are exposed that diatomaceous earth and results in the death of the insect.

It is yet another aspect of at least one embodiment of the present invention to provide for a consumer article selected from the group consisting of mattress filler cloth, mattress ticking, textile fabrics, foamed pillows, foamed cushions, non-woven fabrics, carpets, carpet backing, and combinations there of having an effective amount of diatomaceous earth present on exposed surfaces of the household article, the diatomaceous earth having a portion of the diatomaceous earth particles embedded within a thermoplastic surface and an exposed portion of the particle being present above the thermoplastic surface.

It is yet another aspect of at least one embodiment of the present invention to provide for an article as described above wherein the diatomaceous earth particle has substantially about at least 10% of the diatomaceous earth particle exposed, more preferably in a range of 10 to 35% of the diatomaceous earth particle exposed, and more preferably the range of between 35%-80% of the diatomaceous earth particle exposed.

It is yet another aspect of at least one embodiment of the present invention to provide for an article as described above wherein the article is carpet backing and the diatomaceous earth is present in an amount of at least about 0.2 ounces per square yard.

It is yet another aspect of at least one embodiment of the present, invention to provide for a consumer article as set forth above wherein the article is a mattress filler cloth and the diatomaceous earth is present on a coated surface within the cloth and the concentration of about 0.1 ounce per square yard.

It is yet another aspect of at least one embodiment of the present invention to provide for a process of applying diatomaceous earth to a thermoplastic substrate comprising the steps of supplying a substrate having a thermoplastic surface; raising a temperature of the thermoplastic surface to a softening point; applying an effective amount of diatomaceous earth to the thermoplastic surface; applying an effective amount of pressure so as to embed the diatomaceous earth within the thermoplastic substrate such that a portion of the diatomaceous earth particles remain exposed above a surface of the substrate; cooling the substrate and thereby substantially embedding the diatomaceous earth to the substrate wherein a portion of the substrate is adhered within the molten material and a portion of the diatomaceous earth is exposed along a surface along the substrate.

It is yet another aspect of a least one embodiment of the present invention to provide for a consumer article having an integral thermoplastic substrate, thermoplastic substrate further comprising one of a yarn, a fiber, foam, fabric, fabric tape, and bedding material.

It is yet another aspect of at least one embodiment of the present invention to provide for a process in resulting product of making an insect resistant film comprising the steps of: supply a film substrate; raising a surface temperature of at least one surface of the film to a temperature that renders the film surface molten; applying DE to the molten film surface; applying pressure to the molten film surface having the applied DE; cooling the film substrate, thereby providing a film having at least one surface of the film having a plurality of embedded DE particles present within the film surface and further comprising having a portion of the DE particles exposed above a surface of the film. Preferably, the diatomaceous earth is present on a surface of the film at a concentration of a least about 0.1 ounces per yard.

It is yet another aspect of at least one embodiment of the present invention to provide for a process and an article made by the process in which DE is applied to a substrate having a thermoplastic component and comprising the steps of: supplying a substrate having at least a portion of an exposed surface comprising a thermoplastic material; heating a DE to a temperature above the molten temperature of the thermoplastic material; applying the heated. DE to the substrate, the DE adhering to the thermoplastic material and then optionally pressing the substrate to partially embedded the DE into the thermoplastic material. The process of applying the heated DE to the substrate can additionally include using, a heated fluid so as air, to direct the DE to the substrate.

It is yet another aspect of at least one embodiment of the present invention to provide for a textile product and a process of making the textile product in which the textile product has insect resistance and comprising the steps: weaving a fabric when at least one of the yarns used in the fabric defines a surface having DE embedded in a surface of the yarn and wherein at least about 10% of the embedded DE is exposed on the yarn surface and more preferably at least about 35% of the embedded is exposed in the yarn surface and still more preferably a range of between 50% to 85% of the embedded DE is exposed, on the yarn surface.

These and other features, aspects, and advantages of the present invention will become better understood with reference to the following description and appended claims

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 illustrates a process of applying—E powder to a coated substrate or has thermoplastic fibers such as a fabric that involves heating the substrate, applying the DE powder, and then pressing the substrate and DE powder so as to adhere the DE powder within the molten thermoplastic material.

FIG. 2 illustrates a process of applying a DE powder to a substrate that may not have a thermoplastic component, followed by the addition of a thermoplastic coating on top of the DE powder and then pressing and cooling the substrate.

FIG. 3 illustrates a process in which a DE can be applied using heated pressurized air and applied to a thermoplastic substrate prior to the substrate being pressed and cooled.

FIG. 4 illustrates a process of applying DE to an extruded film in which the DE is applied following extrusion while the polymer is still in a softened temperature. Following application of the DE, the film is pressed and cooled to provide a DE coated film.

FIG. 5 illustrates a process of applying to an extruded yarn or fiber DE which is blown onto the extruded yarn or fiber at an elevated, molten temperature followed by cooling to provide a yarn of fiber having a coding of DE.

FIG. 6 illustrates a process of vacuum embedding DE using any heated air source with DE that can be applied to a porous substrate such as a yarn. Following application of the heated air with DE to the substrate, the substrate is pressed and cooled.

FIG. 7 illustrates a fabric component having deposited on an exposed thermoplastic surface a plurality of DE particles.

FIG. 8 illustrates a paper substrate having a plurality of DE particles partially embedded within a surface polymer.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

It is to be understood that the ranges mentioned herein include ail ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

In describing any of the various figures or charts or tables herein, the same reference numbers may be used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

It has long been known that diatomaceous earth is a natural material offering substantial protection against arthropods. Little has been done to incorporate diatomaceous earth into our living environments. One aspect of this invention is to protect the surfaces that we live on or around that can be potential homes for the pests. This invention offers technical solutions to introduce diatomaceous earth in a persistent and long wearing maneuver, onto the surfaces of textile materials, films and foams used, to furnish our living environments.

Whether these textile materials and foams are made of thermoplastic polymers or whether we apply DE containing thermoplastic coatings, we have the opportunity to embed diatomaceous earth into the surfaces to impart protection against arthropods.

In accordance with this invention, it has been found that at a certain loading level of diatomaceous earth, and where a portion of the DE is exposed on the surface of a fiber or film, the fiber or film can provide for a inhospitable environment for insects such that upon coming in contact with the fiber, fabric, film, or foam, the exposed diatomaceous earth particles will rapidly kill the insect. The materials that can be treated are described in more detail below but can include extruded fibers, coated fibers, woven, fabrics having composite threads or fibers treated so as to have a partially exposed diatomaceous earth particles present, and an effective amount and sufficiently exposed to render the diatomaceous earth surface effective for killing insects. Additionally, non-woven fiber webs and melt blown fabrics can be similarly treated along with film surfaces that are also treated and processed so as to an effective amount of exposed diatomaceous earth secured to the surface of the film.

U.S. Pat. No. 9,475,034 describes some methods for bonding particulate materials to a fiber surface. The teachings of this patent, which is incorporated herein by reference, can provide a starting point for incorporating diatomaceous earth within a meltable substrate. However, it is important that the diatomaceous earth be present at specific loading levels and carefully applied through processes that will permanently adhere the diatomaceous earth particles to the substrate while at the same time leaving enough of the diatomaceous earth particle exposed such that it can interact with an insect that comes in contact with the substrate.

Diatomaceous earth (DE) is a naturally occurring siliceous sedentary rock that as easily crumbled into a powder form. It typically has a white to off-white powder and a particle size ranging from less than 3 micrometers to more than 1 millimeter but typically is supplied in a range of 10 to 200 micrometers.

For the uses described below, DE can be obtained in, a milled or micronized form and typically between 10 micrometers to 50 micrometers and is used for insecticides. Suitable grades of DE can be obtained from a wide number of supplies. As used herein, it is believed that a food grade DE is suitable for use in the coating processes and the formation of fabric and other materials.

Set forth below are various methodologies and processes that can be used to apply DE to a thermoplastic surface so as to crater a useful article having at least a portion of the articles exposed surfaces created with an effective amount of diatomaceous earth. As used herein, an effective amount means a loading level and particle size that combines to provide an exposed surface of diatomaceous earth which is partially embedded into a thermoplastic material and which has the ability to function as an insecticide for killing insects. The particular process used to apply the product depends largely on conventional manufacturing processes of the articles to be treated. As seen below, a wide number of coating processes can be utilized which is compatible with conventional manufacturing techniques. By the proper selection of loading level, particle size, and the type of application process, including temperature selection and applied pressure, it is found that an effective amount of diatomaceous earth can be provided to a wide number of useful articles.

Method A is useful to treat surfaces of thermoplastic polymeric materials that otherwise would not be coated in a separate process. Examples of products made of these materials are fibers and films that are melt extruded. Method A takes advantage of introducing DE onto the surface of a fiber or film just as it cools from the molten liquid to solid state. The DE powder is partially embedded to provide permanency for the life cycle of the product and partially exposed to provide an active harsh pesticial surface.

Method B is useful to treat fabrics and textile surfaces that are normally coated for a variety of reasons. These include but are not limited to, tensile strength, seam slippage, ravel resistance, hand modification, wear resistance, wear properties, coloration by pigment binding, hydrostatic resistance, porosity control, and stain resistance. These coated textiles include but are not limited to, upholstery fabrics, drapery fabrics, window covering, industrial construction fabrics, bedding fabrics, mattress cover fabrics, bedding foundation fabrics, mattress edging tapes, industrial tape fabrics, wall covering fabrics, carpets, rugs, shelf liners, floor coverings, and tape fabrics. These fabrics and textile materials are most often coated with polymers that are thermoplastic in nature. These polymers can also be used to bond DE powder to surfaces for the purpose of providing a natural insecticide bound to surfaces we live on and around. This treated surface will provide a devastating environment for arthropods.

The following methodologies are claimed to incorporate DE onto the surface of fabric, textile, film, and foam structures:

### Process 1:

1A—Apply DE powder, emulsion coat polymer, dry

1B—Apply DE powder, hot melt polymer coat, and then cool.

### Process 2:

2A—Fabric already is coated or has thermoplastic fibers to thermoplastic polymer-heat, apply DE powder, and then cool.

### Process 3—Method A

3A Molten polymer is extruded film or fiber—DE powder applied and then cooled.

### Process 4:

4A—Coated or uncoated—Apply thermoplastic coating hot melt, apply DE powder, and then cool.

4B—Coated or uncoated Apply emulsion polymer coating, dry, apply DE powder while hot, and then cool.

4B1—Coated or uncoated—Apply PVC plastisol coating, fuse, apply DE powder while hot, and then cool.

4B2—Coated or uncoated—Apply soluted, polymer coating, evaporate solvent, apply DE powder while hot, and then cool.

4C1—Coated or uncoated—Apply PVC plastisol coating, introduce DE powder, fuse, and then cool.

4C2—Coated or uncoated—Coat with emulsion polymer, introduce DE powder, dry, and then cool.

4C3—Coated or uncoated—Apply soluted polymer coating, introduce DE powder evaporate solvent, and then cool.

### Process 5:

5A—Coated or uncoated fiber fill batting or nonwoven-coat with emulsion polymer, apply DE powder, dry, and then cool.

5B—Coated or uncoated fiber fill batting or nonwoven with low melt fiber-heat, apply DE powder, and then cool.

5C—Coated or uncoated fiber fill batting or nonwoven—coat with hot melt, apply DE powder, and then cool.

5D—Coated or uncoated fiber fill batting or nonwoven—coat with emulsion polymer, dry, apply DE powder while hot, and then cool.

### Process 6:

6A—Molded or cut foam part— heat, apply DE powder, and then cool.

6B—Molded or cut foam part—apply emulsion polymer coating or soluted polymer, apply DE powder, dry, and then cool.

6C—Molded or cut foam part—apply emulsion polymer coating or soluted polymer, dry, apply DE powder while hot, and then cool.

6D—Molded or cut foam part—apply hot melt coating, apply DE powder, and then cool.

6E—Molded or cut foam part—apply solvent, apply DE powder, evaporate solvent, and then cool.

6F—Molded or cut foam part—melt foam with open flame, apply DE powder, and then cool.

The most appropriate and cost effective method of applying DE onto the surface will depend on the normal process used to manufacture the textile fiber, yarn, carpet, fabric, film, foam or other article.

Set A—DE Powder Delivery Processes include but are not limited to:
Scatter coating
Sintering
Flocking
Sifting
Coating as a slurry of diatomaceous earth in water
Vacuum impregnation (hot)
DE blasting

Set B—Emulsion Thermoplastic Polymers and Solvated Polymers include but are not limited to:
Acrylics, acrylic copolymers, poly vinyl acetate, ethylene vinyl acetate, styrene butadiene polymers, styrene acrylates, polyurethanes, ethylene vinyl chloride, poly vinyl chloride, poly vinyl chlorate acrylate copolymers, polyurethane acrylates
   Set C—Hot melt Polymers, Fibers, and Films include but are not limited to:
Polyester, polyester copolymers, polyamides, polyamide copolymers, polyvinyl acetate, polyvinyl acetate copolymers, olefins, olefin copolymers, polyurethanes, polyurethane copolymers, acrylics, aramides, modacrylics.

### Process 1:

1A—Process 1A involves the application of DE powder by any methods listed in Set A onto the untreated fabric, carpet, film, or foam surface as, the first step. The emulsion polymer coating is then applied on top of the DE powder by conventional methods. The DE powder is embedded into the coating but the coating does not totally encapsulate the DE powder. The coating is dried to remove the water and the DE powder is bound at the interface. Arthropods that come in contact will be injured or killed. They will also be threatened and avoid staying or living in that environment.

1B—Process 1B involves the application of DE powder by any methods listed in Set A onto untreated fabric, carpet, film or foam surface as a first step. The hot melt coating is applied on top of the DE powder. When the hot melt polymer (Set C) cools and traps DE powder at the interface. The powder is embedded to prevent dusting. It is also partially exposed and available as a pesticide.

### Process 2:

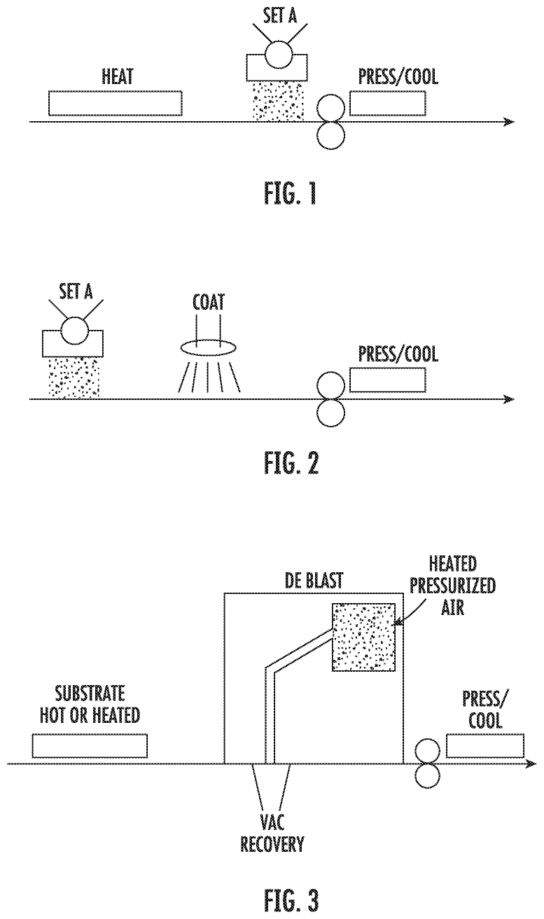

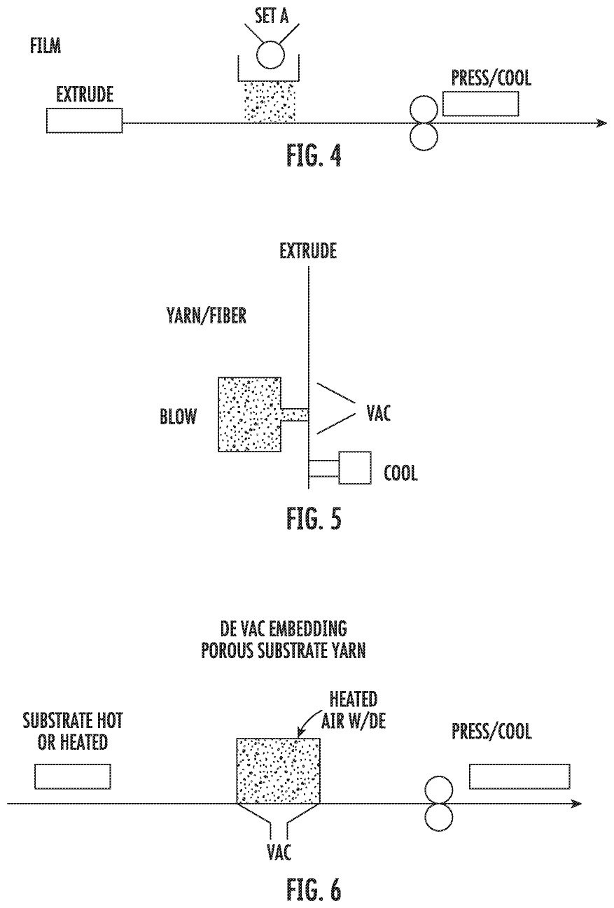

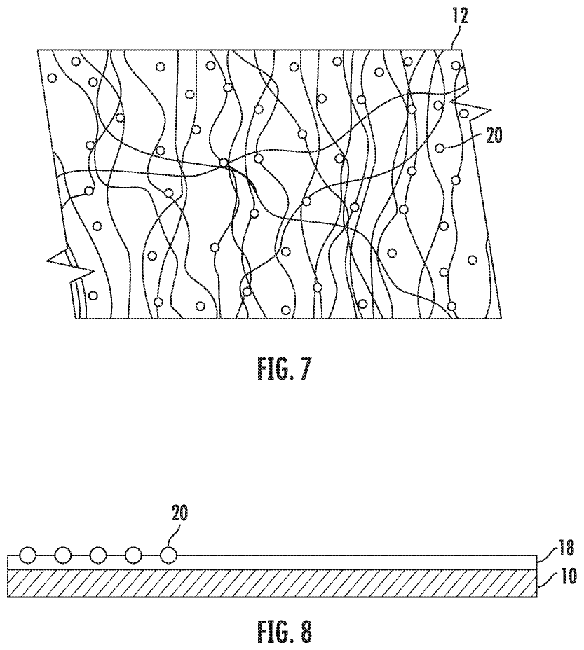

2A—Process 2A involves starting with a carpet fabric, film, or foam surface that already has a thermoplastic coating on the surface to be treated. M Many drapery fabrics, upholstery fabrics, carpets, industrial fabrics, and tapes normally have thermoplastic coating as a part of their structures. These coatings can simply be heated to a temperature that the coating becomes soft and tacky. While the surface is tacky, DE can be delivered by any method listed in Set A. Pressure rollers or similar devices can be used to embed the powder into the softened coating polymer surface. The coating them cools to trap the embedded D.E. The surface can then be brushed to remove any loose DE powder if desired to prevent possible objectionable dusting. (See FIG. 2). Fabrics with coated surfaces like the undersides of mattresses or the tops of foundations can be substantially protected from arthropod infestation when DE embedded surfaces are provided by process 2A. Fabrics such as mattress tapes used to bind the edges and corners normally have thermoplastic coatings applied to enhance sewing and yarn binding. Embedding DE powder into the surface will provide substantial arthropod resistance for insects that try to burrow, crawl, and live in the edges of mattresses or foundations.

A third example of fabrics that are normally coated with thermoplastic polymers that would benefit from the application of DE, powder into the surface is drapery fabrics. Drapery fabrics are often coated with thermoplastic emulsion polymers to provide eight blocking properties. Variations in application can include one, two, three and four coating layers to achieve the desired effects. Normally, cotton dust or silicone finishes are applied to the surface of the outer coating to improve tactile properties. It is known that fabric producers, marketers, consumers, and cutting rooms like the outer coated surface to feel less rubbery. DE powder can be applied instead of cotton or silicone to make the coated surface less rubbery. The DE powder will also substantially protect window covering fabrics and drapes from arthropods that crawl across the surface and attempt to live in the room. Process 2A takes advantage of thermoplastic surfaces already available to bind DE particles.

Film surfaces of polymers (Set C) that are thermoplastic can also be protected by process 2A. One example is shelf liners made of PVC films can be heated and have DE powder embedded with process

2A. The resulting surface will provide protection from arthropod infestation. Fabrics that are constructed of thermoplastic fibers like polyester can have DE delivered to the surface during the heat setting process. drum heaters are often used to heat set polyester. The fabric is heated to 410°-420° F. around the Tg. DE powder can be imbedded in the surface at this temperature by DE blasting with heated air at the same temperature. The fabric is then pressed, cooled and vacuumed to remove loose powder.

### Process 3:

Process 3A involves treating melt extruded surfaces of fibers and films (SET C). DE powder delivered into the outer surface as the polymer cools from its molten liquid state to its solid state will embed the DE powder. The surface will have adequate permancy to protect it for the life cycle of the product from arthropod infestation. The two major product areas there Process 3 is useful is the extrusion of films and the melt extrusion of fibers.

Films that are extruded from hot melt polymers can have DE introduced into the surface using Process 3A. The films can then be used to produce products with highly arthropod resistant surfaces. Packaging films can be treated with DE to provide insect resistant packages. An example of a textile application that will greatly benefit from process 3A is the extrusion of slit film tape yarns. Polyolefins are extruded into films for the purpose of slitting into tape yarns. These yarns are then woven into fabrics to provide economical fabrics for carpet backing and food/feed bags. DE powder can be delivered into the semi-molten film surface just after extrusion and before solidification and cooling using Set A methods. The treated surface then cools to a solid film. The film is then slit and fibrolated to form the yarn. Polyolefins extruded in this manor and treated will make excellent yarns when slit and woven. The DE powder can be delivered into the film at the optimum temperature to embed the particles yet leave them adequately exposed for arthropod protection. Proper embedding will produce excellent permancy and protection for the life cycle of the products. The fabric woven from these treated yarns will be highly arthropod resistant. Additionally, the micro surface roughness provided by the irregularly shaper particles will provide the yarns with a higher coefficient of friction to itself or other surfaces. Feed bags woven from these yarns will not be prone to slipping on each other when stacked. The yarn will also exhibit improved seam slippage. Carpet backing produced with this treated yarn will have better tuff binding properties when used in, tufted carpets. They will also retain fibers better to prevent carpet shedding.

Process 3A provides a high degree of utility with very little change or disruption in normal processing. Carpets manufactured with the primary backing produced from the DE treated film/yarns will be protected from a variety of arthropods. Dust mites that burrow into the face fibers and reach the DE impregnated primary backing will be in a hostile environment. The exposed DE particles will cut into their cuticle layers and exoskeletons producing injury and death. Bed bugs that burrow into the carpet will be likewise affected. The embedded DE will not be removed by vacuuming and extraction resulting in long lasting arthropod resistance.

Fibers that are melt extruded can have DE powder delivered into the outer surface as the molten polymer cools to its solid state. When the DE powder is introduced at the correct surface temperature, the particles will be embedded with adequate, permancy for the life cycle of the fiber. Articles produced with these DE treated fibers will be highly resistant to arthropods. These articles can be washed and cleaned with long lasting arthropod protection.

Fibers and yarns can also be treated with DE by a process described as DE blasting. Pressurized or compressed air is heated to the correct temperature for the polymer to be treated. DE is delivered into the heated air stream and blown into the heated yarn or filler to embed the particles. The force or pressure of the air determines the depth that the particles are embedded into the surface. This process can be, done during the fiber extrusion or in a subsequent process like texturizing or thermal plying. A small port can be added to a conventional yarn texturizing machine to deliver DE into the surface while the yarn is heated near its Tg temperature.

Films used in packaging, shelf liners, yarn manufacturing and covers can be DE blasted to embed DE for insert protection.

Extruded plastic parts and products can be DE blasted as they cool and solidify to embed DE particles. PVC weather stripping and seal products are ideal items to benefit from this treatment. The micro rough surface achieved will cut into the insect's waxy cuticle when in contact with the treated surface. Flexible polymeric seals under doors and windows treated with DE will offer additional protections to occupants from arthropods, Bedding fabrics made DE treated yarns will be resistant to bed bug and flea infestation, Mattress covers and ticking fabric made of DE treated yarns will be hostile environment for arthropod to survive in. Fabrics constructed of DE treated yarns will provide protection against fleas and dust mites. Luggage fabrics made of DE treated yarns will reduce the likelihood of bed bugs being transferred from motels to homes.

### Process 4

Process 4 involves starting with either an uncoated or a previously coated substrate and applying a coating for the purpose of having a polymeric surface to embed DE into.

Process 4a starts with an uncoated or coated substrate and, applies a thermoplastic hot melt (Set C) coating. As the coating cools and solidifies, DE powder is delivered by any method listed in Set A. The DE is embedded yet exposed to achieve the optimum permancy and exposure. Process 4A can include application of powdered plastics that are coated by Set A methods, heated to their melt points and then have DE powder delivered by Set A methods to bond the DE particles to the polymer particles. The substrate is then cooled and vacuumed to remove loose particles if desired. Another option into combine DE particles and plastic particles in the same powder mix before delivering them to the substrate, heating to melt point, and cooling. Process 4B involves starting with a coated or uncoated fabric and, applying an emulsion polymeric coating. (Set E) The coating is then dried and DE is delivered into the surface while the surface is hot and tacky. The DE is delivered using any method listed in Set A. It can then be pressed into the surface with pressure rollers and brushed and or vacuumed to remove loose particles if desired. An example of types of fabric benefiting from process 4B treatment is drapery and upholstery. Fabrics, like coated mattress filler cloth, can also be coated with a dispersion or slurry of diatomaceous earth while cool or hot. The slurry can be 0.05 to 30% solids of DE powder. The coating can be applied by many conventional coating methods including knife coating, rotary screen coating, reverse roll coating, foamed or liquid coatings, roller coatings, or spraying. The coated fabric is then dried to remove water from the slurry. If desired the fabric can be pressed by nip rollers while hot to further embed the diatomaceous earth. Typical dry application levels are 0.025 to 1 ounce/square yard to provide adequate killing powers. Application of 0.1-0.5 oz/sq yd are preferable to minimize dusting with good killing efficacy.

Formulation for Slurry Coating

| | |
|---|---|
| Water | 90 |
| Diatomaceous Earth | 10 |
| Carboxy Methyl Cellulose Thickener J5MS | .5 |

Insects will feel threatened when they crawl across the treated surface and the DE particles cut into their waxy cuticle layer. Additionally, in the case of drapery fabrics, the DE particles will make the polymer surface less rubbery and tacky. The drapery can be coated with lower Tg, softer polymers resulting in better drape. Better drape and softer hand is very desirable in drapery, the DE particle will make the coated surface whiter and improve opacity. Opacity and light blocking is also very important for drapery fabrics. A third example of a group of upholstery fabrics that would greatly benefit from, process 4B are Crypton™ fabrics. These fabrics have thermoplastic polymer coatings on them to provide stain resistance and hydrostatic resistance. Crypton™ fabrics typically have cotton flock applied to coated surface to reduce tack and improve tactile properties and sewing properties. Embedding DE particles into the coated surface instead of cotton flock will achieve similar properties and additionally provide, insect resistance. This is highly desirable in the contract furniture market serving hotels, nursing homes, health care facilities, institutional facilities, and restaurants. These Crypton™ fabrics will also benefit from process 4C2.

Process 4B1 involves starting with a coated or uncoated fabric and applying a PVC plastisol coating. The coating is then fused and while hot and soft, DE powder is delivered into the coated surface using any method listed in Set A. The substrate can then be pressed by pressure rollers and vacuumed free of loose powder if desired. An example of PVC coated fabrics benefitting from having a DE treated surface are shelf liner fabrics. Insects will be less likely to inhabit cabinets with these DE treated surfaces.

Process 4B2 involves starting with a coated or uncoated substrate and applying a solvated polymer coating (Set 2). The solvent is then evaporated and DE powder is delivered using any method in Set A while the polymer surface is hot and soft. The substrate can then be pressed by pressure rollers and later brushed and vacuumed to remove loose powder if desired. One example of a group of fabrics that would benefit from process 4B2 are apparel fabrics such as coated outer wear. Jackets, ponchos, rain suits, etc. can be made to have insect resistance by the application of DE into the coated surface.

Process 4C1 involves starting with a coated or uncoated substrate and applying a PVC plastisol coating. While the coating is in a liquid state, DE powder is introduced by any method listed in Set A. The coated substrate is then fused, pressed and cooled. The surface can then be brushed and vacuumed to remove loose powder if desired. An example of a fabric benefiting from process 4C1 is PVC coated trampolines. Application of DE into the surfaces of these fabrics will provide useful insect resistance.

Process 4C2 involves starting with a coated or uncoated fabric and applying an emulsion polymer coating. (Set 2) While the coating is in the liquid form, DE powder is introduced by any of the methods listed in Set A. The coating is the dried and pressed while hot. After cooling the coated surface can be brushed and vacuumed to remove loose powder if desired. An example of fabrics benefiting from Process 4C2 are drapery fabrics. Additionally, the coated surface will be rendered whiter and less rubbery. These features are highly desirable in drapery fabrics. A second example of fabric benefiting from Process 4C2 are fabrics used in tapes. Mattress edging tape fabrics can be treated by Process 4C2 and sewn into mattresses. The edges and corners of the mattress will be highly protected from arthropods attempting to borough into these spaces. Adhesive tapes with or without release liners can using Process 4C2, These tapes can then be applied to mattress foundation and furniture legs to provide insect protection when arthropods attempt to climb on the taped surfaces.

Process 4C3 involves starting with a coated or uncoated substrate and coating the surface with a solvated polymer coating. (Set B) Before evaporating the solvent, DE powder is introduced into the surface by any method listed in Set A. The solvent is then evaporated, and the surface is pressed while hot. The surface can then be brushed and vacuumed to remove loose powder if desired. An example of a fabric benefiting from treatment by Process 4C3 is medical fluid resistant drapes.

### Process 5—Treatment of Fiber Fill, Nonwovens, or Batting

Process 5A involves starting with a coated or uncoated fiberous fiber fill, nonwoven, or batting and coating the structure with an emulsion polymeric coating. (Set B) The substrate can then be treated with DE powder using any of the methods in Set A. The coating is then dried and pressed if desired. The substrate can then be vacuumed to remove loose powder if desired. An example of nonwoven application benefitting from Process 5A is nonwovens used in constructing mattresses. These nonwovens are extensively used beneath the ticking and above the foam layer in mattresses. Dust mites and bed bugs will be deterred from living in these nonwoven structures when they are treated by Process 5A. Furniture batting can also benefit from treatment with Process 5A.

Process 5B involves starting with an uncoated fiber fill, batting, or nonwoven comprised of a lower melting point fiber and a higher melting point fiber. The material is heated to a temperature sufficient to soften and melt the lower melting point fiber. While the material is hot, DE is delivered using any of the methods in Set A. This material can be any combination of fibers listed in Set C with and fibers of a higher melting point. The material is then cooled and possibly pressed. The material can next be vacuumed to remove loose powder if desired. DE powder will be embedded into the surface of the material with good permancy yet partially exposed to provide substantial arthropod protection.

Process 5C involves starting with an uncoated or coated fiber fill, batting, or nonwoven material and applying a hot melt coating. (Set 3) While the coating is hot DE is delivered using any of the methods listed in Set A. The substrate is then cooled and pressed to embed to DE. The substrate can then be vacuumed to remove loose powder if desired.

Examples of textile substrate that will benefit from Process 5B or 5C are nonwovens used for upholstered, furniture and mattresses. Arthropods attempting to live under the outer upholstery or ticking fabrics will be exposed the DE environment and result in the death of the arthropod.

Process 5D involves starting with a coated or uncoated fiber fill, batting or nonwoven material and applying, an emulsion polymer coating. (Set B) While the coating is wet, DE is delivered using any method used in Set A. The coating is then dried. The substrate is then cooled and pressed. The substrate can then be vacuumed to remove loose powder if desired. An example of textile nonwovens benefitting from process 5D are spray bonded air filtration materials. Dust mites attempting to live on these surfaces will not thrive on the DE embedded surface.

Process 6 involves treating cut urethane foam or molded urethane foam surfaces with DE.

Process 6A involves starting with a molded or cut urethane foam part. The part is heated until the surface is soft and tacky and DE is the delivered using any method listed in Set A. The surface is then cooled to lock DE into the surface. The surface can then be vacuumed to remove excess powder if desired. Arthropods attempting to live in these treated foam surfaces will have a difficult time existing. An example of foam parts benefitting greatly from process 6A are furniture and mattress foam parts.

Process 6B involves starting with a molded or cut urethane foam part and the applying an emulsion polymer or solvated polymer coating. The next step is to apply DE powder to the surface using any method in Set A. the part is then dried to lock the powder into the surface. The part can then be vacuumed to remove loose powder if desired. Process 6B will provide excellent permancy for the DE treated surface where extra wear resistance is required.

Process 6C involves starting with a molded or cut urethane foam part. The part is then coated with an emulsion polymer or solvated polymer coating in Set B. The water or solvent is then dried from the surface and while the surface is hot DE is delivered by any methods in Set A. the surface is then cooled to lock the DE into, the surface. It can then be vacuumed to remove loose powder if desired.

Process 6D involves starting with a molded or cut urethane foam part. The part is coated with a hot melt polymer. While the coating is heated and before cooling to the solid state, DE is delivered by any method in Set A. The surface is then cooled to trap the DE powder. The surface can then be vacuumed to remove loose powder if desired.

Process 6E involves starting with a molded or cut urethane foam part. The part is then treated with a solvent that will dissolve the outer urethane surface. DE is applied using any method in Set A before the solvent evaporates. When the surface solidifies, the DE powder is locked into the surface.

Process SF involves starting with a molded or cut urethane foam part. The part is exposed to an open flame to melt the outer surface. While the surface is melted, DE is delivered onto the molten surface using any method listed in Set A. The part is then cooled to lock the DE Powder in place, and it can then be vacuumed to remove loose powder if desired. An example of products benefitting from process 6F are urethane foam scribed roll goods. These produced are cut from the foam and rolled to be used in thin foam applications.

The process described above is particularly useful for producing a carpet in which portions of the carpet, have a portion of the diatomaceous earth particle exposed while a portion of the diatomaceous earth particle is embedded within a thermoplastic component of the carpet. With respect to tufted carpet, the diatomaceous earth can be incorporated into a primary backing fabric. Additionally, the diatomaceous earth can also be applied to a secondary backing fabric on a tufted carpet. With respect to a woven carpet, the diatomaceous earth can be, placed on one or both of the interlacing faces yarns or the backing yarns. Within the woven yarn industry it is common to have a small amount of a latex backed coating applied to the yarns, and the diatomaceous earth could also be included on the exposed surfaces of the latex backed coating.

Set forth below in Table 1 and Table 2 are graphs of the efficacy of DE embedded on a coated surface of a mattress filler cloth (Table 1) and a primary backing for a carovet (Table 2). The mattress filler cloth was coated with 0.1 ounces/square yard of DE and bed bugs were placed on a sample of the treated filler cloth. As seen in Table 1, the y axis of percent kill shows that after 9 days (x axis) 100% of the bed bugs were killed.

As seen in Table 2, a coating of 0.2 ounces per square yard of DE was applied to a primary carpet backing. As seen in Table 2, 100% of the bed bugs were killed by day 3.

It is also noted that once bed bugs have encountered a DE containing substrate, they tend to avoid laying new eggs. This attribute, further limits the spread of bed bugs by interrupting the reproduction cycle.

The use of diatomaceous earth, permanently applied to a substrate such as through the processes described above, allows for a wide range of consumer and industrial articles to be manufactured in which the manufactured article has an effective amount of diatomaceous earth exposed on one or more surfaces of the article. With respect to fabrics, the fabrics can be utilized to make variety of articles where insect resistance if useful. These include articles such as mosquito netting, draperies, carpets, luggage, and similar articles.

The diatomaceous earth can also be embedded in a thermoplastic surface or otherwise adhered to a surface of a number of useful consumer and industrial goods in order to provide effective barriers and surfaces that will kill insects. For instance, floor moldings that are used in commercial buildings are often a vinyl or thermoplastic material which, when treated with an effective amount of diatomaceous earth on the surface of the molding, provides a barrier that will damage and kill insects that may come in contact with the barrier.

Diatomaceous earth can also be incorporated into plastic films that are used as vapor barriers within the crawl space of a house. By treating one or both surfaces of the vapor barrier, a number of insect pests can be controlled that normally inhabit the crawl space of a residential structure or building.

The diatomaceous earth can also be incorporated into a vapor barrier used on the sides of buildings such as those sold under the brand name of Tyvex®. Just as the vapor barrier is used to effectively seal a house against the passage of moisture, by treating the vapor barrier surfaces, an insect barrier can also be provided that will kill insects that are crawling across the surface of the barrier.

As set forth in FIG. 7, a representative fabric 12 can be provided which has embedded therein DE particles 20. As described elsewhere herein, the DE particles 20 are partially exposed above the fiber, yarn, or other thermoplastic coating that is associated with the fabric so as to render an exposed surface having a plurality of DE particles.

Set forth in FIG. 8 is an additional embodiment of the present invention in which the DE particles 20 are attached to a paper substrate 10 by being partially encapsulated within a thermoplastic polymer 18 present on at least one surface of paper 10. Any number of conventional thermoplastic polymers can be used to coat the paper in which provides a heat softening surface in which diatomaceous earth particles can be added. Suitable polymers include various grades and forms of polyethylene, high density polyethylene, along with other thermoplastic materials such as nylon, PET, and various adhesive tie layers as are known and conventional within the art. While FIG. 8 sets forth an embodiment in which only a single surface of paper 10 has the thermoplastic layer 18 and DE particles 20, the bottom portion of the paper substrate 10 could have an identical layer of thermoplastic polymer 18 and DE particles 20.

Both a fabric substrate as seen in FIG. 7 and a paper substrate seen in. FIG. 8 can be used to provide for a material to treat and control insect populations. For instance, a suitable fabric, a suitable paper, or a thermoplastic material such as a rubber sheet can all be provided having an upper surface layer having DE particles partially embedded therein. The substrates can be used as shelf liners within a kitchen food preparation area, drawer liners in bathroom drawers and dresser drawers, and can be utilized in other storage spaces including storage boxes used in warehouses so as to provide a substrate that will minimize infestation of insects.

Low cost paper and/or plastic sheet substrates having an upper surface of partially exposed DE can be used to create an environment that reduces the population of insects within the area. For instance, kitchen cabinets, food storage areas, environments associated with trash containers can all have the immediate environment treated by placement of fabric sheets or paper sheets that wilt come in contact with insects that may be attracted to such locations.

An additional useful article having an effective amount of diatomaceous earth present on at least one of the surfaces includes the use of a textile fabric or geo-textile fabric that may be used in agricultural or gardening applications. Frequently, desired garden plants, flowering plants, and ornamental plants grown by nurseries will utilize a plastic and or a fabric ground cover that is designed to prevent weeds, regulate soil temperatures, and regulate soil moisture. In many such applications, the textile fabric is exposed and extends between multiple plants within a garden, farm, or other horticultural facility. By providing a diatomaceous earth surface to the article, the migration of many crawling insect pests that come in contact with the treated surface can be controlled.

Fabrics and other materials having, an effective amount of diatomaceous earth on the surface can also be used in conjunction with insect bait stations where insects are attracted to bait but must crawl across or between surfaces that have been treated with diatomaceous earth. Accordingly these bait stations, can utilize the non-toxic properties of diatomaceous earth to control insect populations. Such bait stations can be used within residential and commercial structures and in protected bait stations that can be positioned in an exterior location of a building.

Other articles of diatomaceous earth treated surfaces can involve fabric sleeves and or films that are utilized as a covering for furniture legs. For instance, in hotel rooms, a fabric sleeve or an applied film can be used on the feet and legs of a bed frame so as to provide a barrier that will kill crawling insects that may migrate up or down the leg.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A household article selected from the group consisting of mattress filler cloth, mattress ticking, textile fabrics, foamed pillows, foamed cushions, non-woven fabrics, carpets, carpet backing, and combinations there of having an effective amount of diatomaceous earth present on exposed surfaces of the household article, the diatomaceous earth having a portion of the diatomaceous earth particles embedded within a thermoplastic surface and an exposed portion of the particle being present above the thermoplastic surface.

2. The article according to claim 1 wherein the diatomaceous earth particle has substantially about at least 10% of the diatomaceous earth particle exposed, more preferably in a range of 10 to 35% of the diatomaceous earth particle exposed, and more preferably the range of between 35%-80% of the diatomaceous earth particle exposed.

3. The article according to claim 2 wherein the article is carpet backing and the diatomaceous earth is present in an amount of about 0.2 ounces per square yard.

4. The household article according to claim 2 wherein the article is a mattress filler cloth and the diatomaceous earth is present on a coated surface within the cloth and the concentration of about 0.1 ounce per square yard.

5. A process of applying diatomaceous earth to a thermoplastic substrate comprising the steps of:
supplying a substrate having a thermoplastic surface;
raising a temperature of the thermoplastic surface to a softening point;
applying an effective amount of diatomaceous earth to the thermoplastic surface;
applying, an effective amount of pressure so as to embed the diatomaceous earth within the thermoplastic substrate such that a portion of the diatomaceous earth particles remain exposed above a surface of the substrate;
cooling the substrate and thereby substantially embedding the diatomaceous earth to the substrate wherein a portion of the substrate is adhered within the molten material and a portion of the diatomaceous earth is exposed along, a surface along the substrate.
